(19) United States
(12) Patent Application Publication
(10) Pub. No.: US 2004/0244444 A1
(43) Pub. Date: Dec. 9, 2004

(54) Portable conduit locking security system

(76) Inventor: John Wadsworth, Hiram, GA (US)

Correspondence Address: Eric R. Katz, 2007 Towne Lake Heights, Woodstock, GA, 30189, US

(21) Appl. No.: 10/456,285

(22) Filed: Jun. 6, 2003

(51) Int. Cl. B65D 55/14; E05B 35/08

(52) U.S. Cl. 70/168; 70/337

(57) ABSTRACT

A conduit locking security system is provided for locking a conduit opening having a flange for supporting a conduit cover. The system includes a locking cover plate for securing the conduit opening against unauthorized access, the locking cover plate being insertable into the conduit opening in a manner so that the conduit cover can overlie the locking cover plate. Also provided is a locking mechanism for locking the cover plate in the conduit opening, the locking mechanism having a key hole for accepting a conduit locking key for moving the locking mechanism between a locked and an unlocked position. In addition, a lockable key hole cover plate is included for covering and preventing unauthorized access to the key hole and locking means is provided for locking and unlocking the key hole cover plate, wherein the locking means is operated by a key different from the conduit locking key used to operate the locking mechanism.

### BACKGROUND OF THE INVENTION

1. Field of the Invention

This invention generally relates to a portable conduit locking security system for preventing unauthorized access to a conduit and, more particularly to a portable conduit locking security system for securing waste storage facilities against unauthorized dumping.

2. Background of the Invention

Federal, State and Local Environmental regulations specify the requirements for the proper disposal of waste products, such as petroleum or grease. As a result, restaurants, grocery store, and retail outlets, to name a few examples, must take special measures to comply with these regulations, such as providing storage tanks or grease traps that hold the waste products for pick-up. Typically, the storage tank or grease trap is located in the ground under a parking lot or paved area so that large tanker trucks can be positioned close to a man-hole covered conduit that provides access to the grease trap. To access the contents of the grease trap, the manhole cover is removed and the waste is then pumped out of the grease trap into the tanker truck for transport to a waste processing facility where the waste is processed and then safely dumped in a land fill or the like.

Due to the cost of complying with such environmental regulations, improper disposal of waste, such as illegal dumping, is a problem. This is a particular difficulty for companies in compliance with these regulations when waste products are illegally dumped into their storage tanks or grease traps. As result, there is a need for preventing unauthorized access to such waste storage facilities.

A typical example of a prior art arrangement for restricting access to a manhole covered conduit is disclosed by U.S. Pat. No. 1,204,464 which relates to a meter box that utilizes a specially adapted manhole cover having a locking device for locking the manhole cover to the associated conduit. The locking device comprises a rotatable plate having a plurality of retractable lock rods that are held in place via spring bias. A special key is used to operate the locking device. While operationally effective, such prior art devices are expensive to retro-fix to existing manholes because a new and expensive manhole cover, that is structurally strong enough to handle the weight traffic, must be manufactured and installed to replace the existing manhole cover. Another problem with this type of approach is that the same special key is used to lock and unlock the cover so that if the key falls in to the wrong hands, every locked meter box can be opened without authorization. In addition, the requirement that the device be spring biased in order to operate makes this arrangement more expensive to manufacture and maintain as well as making this arrangement prone to malfunction.

A locking manhole insert is disclosed by U.S. Pat. No. 5,328,291 to Wisniewski for securing equipment that might be placed in a manhole. The locking manhole includes a plate-shaped insert body that fits into a conventional manhole frame and a series of locking arms attached to an actuating disc mounted on an underside of the insert body. The actuating disc includes an actuating handle extending through the insert and accessible from the top of the insert. The radial arms are retracted and extended by operating the handle. The handle is aligned with a fixed ear when the radial arms are in the extended position enabling the handle to be padlocked to the fixed ear to prevent the radial arms from retracting. Chains are mounted to the undersurface of the insert from which equipment, such as pollution monitoring sampling unit, can be suspended in the manhole.

One drawback of the Wisniewski invention is that once the padlock is removed, for example, using a bolt cutter or the like, the handle can be freely operated and unauthorized access to the manhole gained. In addition, the locking manhole insert of Wisniewski makes no provision for use by businesses that have a plurality of waste storage sites located at disparate locations that require periodic removal and transport of the contents to a waste treatment facility. In this regard, Wisniewski makes no provision for addressing the problem of having different keys to operate the padlock for each manhole cover insert. As a result, it would be difficult for a waste removal crew to match the specific key for a specific manhole insert for each waste storage site of a given business. Moreover, in order to secure the insert in the manhole, the padlock must be used to lock the retracting radial arms in place, otherwise, the radial arms will not stay in place and the insert can be easily removed by giggling the insert to cause the radial arms to retract.

Another approach to sealing a manhole against unauthorized access is to use a lock bar and padlock combination to lock the manhole closed. While simple and inexpensive, the lock bar can be easily removed by cutting the padlock with a bolt cutter. In addition, the lock bar which extends over the manhole cover is prone to damage the tires of vehicle that drive over it.

### SUMMARY OF THE INVENTION

Accordingly, it is an object of the present invention to provide a portable conduit locking security system to prevent unauthorized access to a conduit that overcomes the deficiencies of the prior art.

Another object of the present invention to provide a portable conduit locking security system that is easily retrofitted to existing conduits without the need for replacing an existing manhole cover.

Yet another object of the present invention is to provide a portable conduit locking security system that utilizes two different locking arrangements to limit access and provide a better security from unauthorized entry to the conduit.

Another object of the present invention is to provide a portable conduit locking security system that is particularly adapted for use by businesses having a plurality of waste storage sites at disparate locations that require periodic removal of the store waste for transport to a waste disposal facility by employing two different locking systems wherein the key used to obtain access to the keyway for unlocking the security system is different for each different business but is the same for each waste storage location of a given business.

A further object of the present invention is to provide a portable conduit locking security system that is light weight, easy to use and can be easily transported for use a different locations.

Still another object of the present invention is to provide a portable conduit locking security system that is adjustable so that it can be applied to openings having different sizes.

The present invention can be advantageously used to prevent access to waste storage sites, but is also be adapted for use with almost any type of conduit having opening flanges. In addition to the foregoing, the present invention does not require extensive construction around the conduit opening in order to adapt the opening for use with the present invention. Furthermore, the present invention is adjustable to allow for slight flaws in the existing opening flanges. Moreover, since the present invention is easily portable, it can be moved to different openings and because it is recessed within the opening, the original conduit cover or manhole cover can be used without modification.

To accomplish these and other objects as well as advantageous features, the present invention, according to one embodiment thereof, comprises a portable conduit locking security system for locking a conduit opening having a flange for supporting a conduit cover, the system comprising: a locking cover plate for securing the conduit opening against unauthorized access, the locking cover plate being insertable into the conduit opening in a manner so that the conduit cover can overlie the locking cover plate; a locking mechanism for locking the cover plate in the conduit opening, the locking mechanism having a key hole for accepting a conduit locking key for moving the locking mechanism between a locked and an unlocked position; a lockable key hole cover plate for covering and preventing unauthorized access to the key hole; and locking means for locking and unlocking the key hole cover plate, wherein the locking means is operated by a key different from the conduit locking key used to operate the locking mechanism.

### BRIEF DESCRIPTION OF THE DRAWING

FIG. 1 is a side view, partially in-section, illustrating the portable conduit locking security system of the present invention inserted into a manhole;

FIG. 2 is a top, planar view of the portable conduit locking security system of the present invention;

FIG. 3 is a top, perspective view of the portable conduit locking security system of the present invention;

FIG. 4 is a side, perspective view of the portable conduit locking security system of the present; and

FIG. 5 is a bottom, planar view of the portable conduit locking security system of the present invention.

### DETAILED DESCRIPTION OF THE PREFERED EMBODIMENT(S)

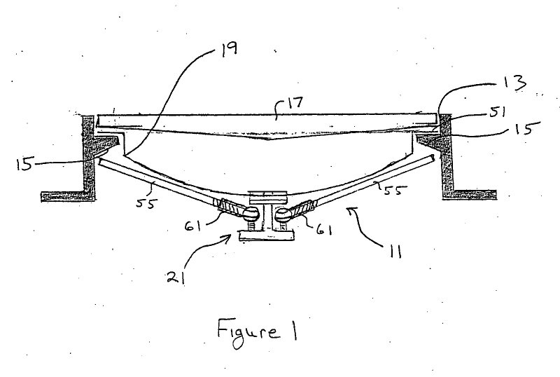

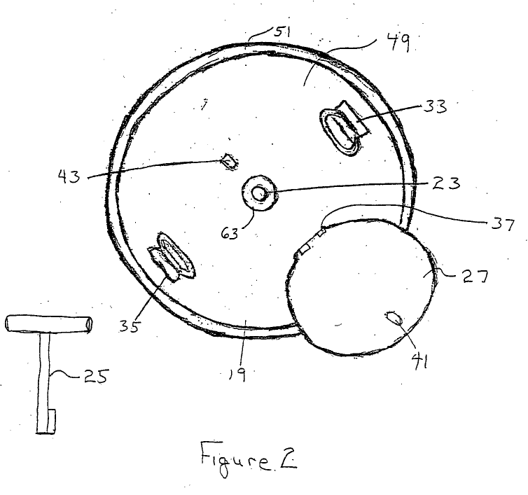

Referring to FIG. 1, a portable conduit locking security system, generally shown at 11, is shown for locking a conduit opening 13 having a flange 15 for supporting a conduit cover 17, such as, for example, a manhole cover or the like. The system 11 includes a locking cover plate 19 for securing the conduit opening 13 against unauthorized access, the locking cover plate 19 being insertable into the conduit opening 13 in a manner so that the conduit cover 17 can overlie the locking cover plate 19. A locking mechanism, generally indicated at 21, is provided for locking the cover plate 19 in the conduit opening 13, the locking mechanism 21 having a keyway or keyhole 23 (as best seen in FIG. 2) for accepting a conduit-locking key 25 for moving the locking mechanism 21 between a locked and an unlocked position

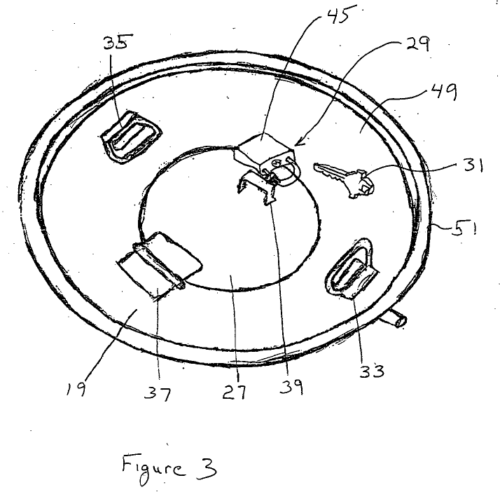

Referring to FIGS. 2 and 3, a lockable keyhole cover plate 27 is provided for covering and preventing unauthorized access to the keyhole 23. In addition, a locking means, generally indicated at 29, is provided for locking and unlocking the keyhole cover plate 27. An important aspect of the present invention is that, the locking means 29 is operated by a key 31, which is different from the conduit-locking key 25 used to operate the locking mechanism 21.

The keyhole cover plate 27 is pivotally mounted to the locking cover plate 19 by, for example, hinge 37 so that it can be moved to uncover the keyhole 23 of the locking mechanism 21 by grasping a keyhole cover plate handle 39. To lock the keyhole cover plate 27 in the closed position, as best seen in FIG. 3, the locking cover plate 19 is provided with, for example, a lock hasp opening 41 adapted to receive a lock hasp 43 attached to the locking cover plate 19. Once the keyhole cover plate 27 is closed, a lock, for example, a padlock 45, is inserted though the lock hasp 43 and locked in place.

The locking cover plate 19 is constructed, for example, from 10 gauge steel and therefore is relative lightweight and portable so that it can be picked up and moved to different locates by a healthy individual. To facilitate such handling, the plate 19 is provided, for example, with a pair of handles 33, 35.

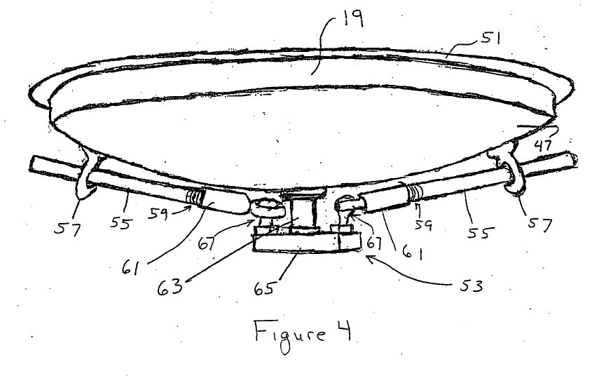

As best seen in FIG. 4, the cover plate 19 preferably comprises a dish-shaped plate having a dished-out bottom surface 47 for insertion into the conduit, a flat top surface 49 (as shown in FIGS. 2 and 3) accessible from outside the conduit and a peripheral flange 51 adapted to rest on the flange 15 at the conduit opening 13. The locking mechanism 21 comprises a lock actuator, generally indicated at 53, at the dished-out bottom surface 47 of the cover plate 19. The lock actuator 53 is rotatably movable by use of the key 25 between the locked position and the unlocked position.

A pair of extendable locking arms 55 are extended by the operation of the lock actuator 53 to engage the flange 15 at the conduit opening 13 to lock the cover plate 19 in the conduit opening 13 when the lock actuator is rotated to the locked position and are retracted to disengage the flange 15 of the conduit opening 13 to unlock the cover plate 19 from the conduit opening 13 when the lock actuator 53 is rotated to the unlocked position. Also included are guide means 57 at the bottom surface 47 of the cover plate 19 for guiding the locking arms 55 as the locking arms 55 are extended and retracted. The location of the lock actuator 53 beneath the dished-out bottom surface of the cover plate 19 in combination with the location of the guide means 57 at the bottom surface 47 assures that the locking arms are positioned beneath the flange 15 of the conduit opening 13 and provided with an upward slope so that the arms 55 firmly engage the underneath of the flange 15 at conduit opening 13 and securely lock the conduit locking system 11 in the conduit opening 13.

As best seen in FIGS. 1 and 4, the length of each extendable locking arm 55 can be independently adjusted so that the conduit locking security system 11 can be specifically adapted to the requirements of each different conduit opening. To accomplish this feature, the attachment ends of the locking arms 55 at the lock actuator 53 are threaded, as shown at 59, and received by a threaded sleeve 61 attached to the locking actuator 53 as will be more fully described below. Therefore, the length of each of the locking arms 55 can be lengthened or shortened by either threading the arms 55 out of or into the associated threaded sleeve 61.

The lock actuator 53 comprises a rotatable shaft 63 extending from the bottom surface 47 through the cover plate to the top surface 49 as best seen in FIG. 2. The rotatable shaft 63 has the keyway or keyhole 23 for accepting the conduit-locking key 25, which, when inserted, is used to rotate the shaft 63 to lock and unlock the system 11. Thus, the rotatable shaft 63 has a top end accessible at the top surface 49 of the cover plate 19 with the keyway 23 for receiving the conduit-locking key 25 and a bottom end extending to and out of the bottom surface 47 of the cover plate 19, the shaft being movable between the locked and unlocked position by the key 25.

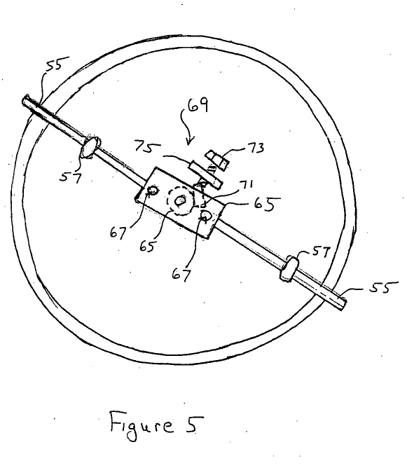

The rotatable shaft 63 has an arm support means 65 attached at the bottom end of the shaft 63 for supporting the pair of locking arms 55 at a radial distance from the axis of rotation of the rotatable shaft 63. Locking arm attachment means, generally indicated at 67, are provided at the support means 65 for attaching the threaded attachment end 59 of each of the locking arms 55 to the arm support means 65 with rotary movement in every direction. This freedom of movement of the threaded attachment ends 59 of the locking arms 55 is necessary because the locking arms 55 tend to twist as they are extended and retracted due to the unique positioning of the locking arms 55 on the support means 65 which is located beneath the dish-out bottom surface 47 of the cover plate 19. The locking arm attachment means 67 comprise, for example, a ball joint wherein the balls of each joint are attached opposite to one another at the arm support means 65 and the threaded sleeves 61 are provided with a socket for completing the ball and socket joint. In addition, a stop, generally indicated at 69, in FIG. 5, is provided for stopping the rotatable arm support means 65 at the locked position.

Referring to FIG. 5, since the ball joints of the locking arm attachment means 67 are positioned opposite one another on the arm support means 65, the attachment ends 59 of the pair of extendable locking arms 55 are attached to the arm support means 65 opposite to one another. In addition, the guide means 57 are positioned so that the pair of extendable locking arms 55 form a substantially straight line when the pair of extendable locking arms 55 are fully extended position. As best seen in FIG. 5, the stop 69, which is adjustable and defines the locked position, is located so that the rotatable arm support means 65 is stopped when the arm support means is rotated slightly beyond the fully extended position of the pair of extendable locking. The stop 69 comprises an abutment 71 attached to, for example, the rotatable shaft 63 by welding. The abutment 71 engages a threaded screw 73 which engages a block 75 having a threaded hole for receiving the screw 73. By threading the screw 73 into or out of the threaded hole of the block 75, the stop 69 can be adjusted.

In accordance with the teachings of the present invention, there is further provided a process for using the system 11 particularly when the conduit opening 13 leads to a waste storage tank. In this regard, waste storage tanks, such as grease traps and the like, are now employed by a variety of businesses such grocery stores, retail stores and restaurants. It is also common for such businesses to have a chain of stores at different location with each store having a waste storage tank. In addition, such business contract with waste disposal companies which pump out the waste from the storage tanks for transport to a waste treatment plant.

To simply the use of the system 11 by waste disposal company that pumps the waste out of the storage tank and prevent difficulties arising from the use of different keyhole cover plate keys 31 for each location, the present invention envisions using the same keyhole cover plate key 31 for all the locations of a given chain, but a different keyhole cover plate key 31 for each of different chain.

Although the present invention has been described in terms of specific exemplary embodiments, it will be appreciated that various modifications and alterations might be made by those skilled in the art without departing from the spirit and scope of the invention as specified in the following claims.

What is claimed is:

1. A conduit locking security system for locking a conduit opening having a flange for supporting a conduit cover, the system comprising:
a locking cover plate for securing the conduit opening against unauthorized access, the locking cover plate being insertable into the conduit opening in a manner so that the conduit cover can overlie the locking cover plate;
a locking mechanism for locking the cover plate in the conduit opening, the locking mechanism having a key hole for accepting a conduit locking key for moving the locking mechanism between a locked and an unlocked position;
a lockable key hole cover plate for covering and preventing unauthorized access to the key hole; and
locking means for locking and unlocking the key hole cover plate, wherein the locking means is operated by a key different from the conduit locking key used to operate the locking mechanism.

2. A conduit locking security system according to claim 1, wherein the cover plate comprises a dish-shaped plate having a dished-out bottom surface for insertion into the conduit, a top surface accessible from outside the conduit and a peripheral flange adapted to rest on the flange of the conduit opening.

3. A conduit locking security system according to claim 1, wherein the locking mechanism comprises:
a lock actuator, at the bottom surface of the dish-shaped plate, rotatably movable between the locked position and the unlocked position;
a pair of extendable locking arms having ends freely attached on the lock actuator, the locking arms extend to engage the flange of the conduit opening to lock the cover plate in the conduit opening when the lock actuator is rotated to the locked position and retract to disengage the flange of the conduit opening to unlock the cover plate from the conduit opening when the lock actuator is rotated to the unlocked position, wherein the locking arms form a substantially 180 degree angle in a fully extended position and wherein the locked position is set slightly beyond the fully extended position of the locking arms; and
guide means at the bottom surface of the cover plate for guiding the locking arms as the locking arms are extended and retracted.

4. A conduit locking security system according to claim 3, wherein the lock actuator comprises:
a rotatable shaft extending through the cover plate, the rotatable shaft having a top end at a top surface of the cover plate with a key way for receiving the conduit locking key and a bottom end extending to a bottom surface of the cover plate and movable between the locked and unlocked positions by the key;
arm support means at the bottom end of the shaft for supporting the pair of locking arms at a radial distance from the rotatable shaft;
locking arm attachment means for freely attaching an attachment end of each of the locking arms to the arm support means for rotary movement in every direction; and
a stop for stopping the rotatable shaft at the locked position.

5. A conduit locking security system according to claim 4, wherein the locking arm attachment means comprises a ball joint.

6. A conduit locking security systems according to claim 3, wherein attachment ends of each of the pair of extendable locking arms are attached to the lock actuator opposite to one another and the guide means are positioned so that the pair of extendable locking arms form a substantially straight line when the pair of extendable locking arms are in the fully extended position.

7. A conduit locking security system according to claim 6, wherein the stop is positioned so that the lock actuator is stopped at the locked position when the lock actuator is rotated slightly beyond the fully extended position of the pair of extendable locking

8. A conduit locking security system according to claim 1, wherein the conduit is a manhole and the conduit cover is a manhole cover.

9. A conduit locking security system according to claim 8, wherein the conduit provides access to waste storage tank.

10. A conduit locking security system according to claim 9, wherein the waste storage tank is a grease trap.

11. A conduit locking security system according to claim 9, wherein the waste storage tank comprises one of plurality of waste storage tanks owned by different businesses and wherein key for unlocking the lockable key hole cover plate is different for each of the different businesses.
